(19) United States
(12) Patent Application Publication
(10) Pub. No.: US 2020/0250462 A1
(43) Pub. Date: Aug. 6, 2020

(54) KEY POINT DETECTION METHOD AND APPARATUS, AND STORAGE MEDIUM

(71) Applicant: Beijing Sensetime Technology Development Co., Ltd., Beijing (CN)

(72) Inventors: Kunlin Yang, Beijing (CN); Maoqing Tian, Beijing (CN); Shuai Yi, Beijing (CN)

(21) Appl. No.: 16/855,630

(22) Filed: Apr. 22, 2020

Related U.S. Application Data
(63) Continuation of application No. PCT/CN2019/083721, filed on Apr. 22, 2019.

(30) Foreign Application Priority Data
Nov. 16, 2018 (CN) 201811367869.4

(51) Int. Cl. G06K 9/46; G06K 9/62; G06N 3/04; G06N 3/08

(52) U.S. Cl. CPC G06K 9/4671; G06K 9/629; G06N 3/08; G06N 3/0454; G06K 9/6217

(57) ABSTRACT

A key point detection method includes: obtaining first feature maps of a plurality of scales for an input image, scales of the first feature maps having a multiple relationship; performing forward processing on each first feature map through a first pyramid neural network to obtain second feature maps in one-to-one correspondence to the first feature maps, each second feature map having the same scale as that of its respective first feature map; performing reverse processing on each second feature map through a second pyramid neural network to obtain third feature maps in one-to-one correspondence to the second feature maps, each third feature map having the same scale as that of its respective second feature map; and performing feature fusion processing on each third feature map, and obtaining the position of each key point in the input image through the feature map subjected to the feature fusion processing.

### CROSS REFERENCE TO RELATED APPLICATIONS

This is a continuation of International Patent Application No. PCT/CN2019/083721, filed on Apr. 22, 2019, which claims priority to Chinese Patent Application No. 201811367869.4, filed on Nov. 16, 2018. The disclosures of International Patent Application No. PCT/CN2019/083721 and Chinese Patent Application No. 201811367869.4 are hereby incorporated by reference in their entireties.

### BACKGROUND

Human key point detection is to detect position information of key points such as joints or facial features from a human body image, so as to describe the posture of the human body by means of the position information of these key points.

Since human bodies in an image are different in size, the existing technology may generally obtain multi-scale features of the image by using a neural network for finally predicting the positions of the key points of the human body. However, it is found that multi-scale features cannot be fully mined and utilized by using this method. The detection accuracy of key points is low.

### SUMMARY

The present disclosure relates to the field of computer vision technologies, and in particularly, to provide a key point detection method and apparatus, and a storage medium for effectively improving the detection accuracy of key points.

According to a first aspect of the embodiments of the present disclosure, provided is a key point detection method, including: obtaining a plurality of first feature maps at a plurality of scales for an input image, scales of the plurality of first feature maps having a multiple relationship; performing forward processing on each of the plurality of first feature maps by using a first pyramid neural network to obtain a plurality of second feature maps in one-to-one correspondence to the plurality of first feature maps, wherein each of the plurality of second feature maps has the same scale as that of a first feature map corresponding to the second feature map; performing reverse processing on each of the plurality of second feature maps by using a second pyramid neural network to obtain a plurality of third feature maps in one-to-one correspondence to the plurality of second feature maps, wherein each of the plurality of third feature maps has the same scale as that of a second feature map corresponding to the third feature map; and performing feature fusion processing on each of the plurality of third feature maps, and obtaining a position of each key point in the input image by using a feature map subjected to the feature fusion processing.

According to a second aspect of the embodiments of the present disclosure, provided is a key point detection apparatus, including: a multi-scale feature obtaining module, configured to obtain a plurality of first feature maps at a plurality of scales for an input image, scales of the plurality of first feature maps having a multiple relationship; a forward processing module, configured to perform forward processing on each of the plurality of first feature maps by using a first pyramid neural network to obtain a plurality of second feature maps in one-to-one correspondence to the plurality of first feature maps, where each of the plurality of second feature maps has the same scale as that of a first feature map corresponding to the second feature map; a reverse processing module, configured to perform reverse processing on each of the plurality of second feature maps by using a second pyramid neural network to obtain a plurality of third feature maps in one-to-one correspondence to the plurality of second feature maps, wherein each of the plurality of third feature maps has the same scale as that of a second feature map corresponding to the third feature map; and a key point detecting module, configured to perform feature fusion processing on each of the plurality of third feature maps, and obtain a position of each key point in the input image by using a feature map subjected to the feature fusion processing.

According to a third aspect of the embodiments of the present disclosure, provided is a key point detection apparatus, including: a processor; and a memory configured to store processor-executable instructions; where the processor is configured to execute the method according to the first aspect.

According to a fourth aspect of the embodiments of the present disclosure, provided is a computer-readable storage medium, having stored thereon computer program instructions that, when being executed by a processor, implements the method according to the first aspect.

It should be understood that the above general description and the following detailed description are merely exemplary and explanatory, and are not intended to limit the present disclosure.

The other features and aspects of the present disclosure may be described more clearly according to the detailed descriptions of the exemplary embodiments in the accompanying drawings.

### BRIEF DESCRIPTION OF THE DRAWINGS

The accompanying drawings here incorporated in the specification and constituting a part of the specification illustrate the embodiments consistent with the present disclosure and are intended to explain the technical solutions of the present disclosure together with the specification.

FIG. 1 is a flowchart illustrating a key point detection method according to embodiments of the present disclosure;

FIG. 2 is a flowchart illustrating operation S100 in a key point detection method according to embodiments of the present disclosure;

FIG. 3 is another flowchart illustrating a key point detection method according to embodiments of the present disclosure;

FIG. 4 is a flowchart illustrating operation S200 in a key point detection method according to embodiments of the present disclosure;

FIG. 5 is a flowchart illustrating operation S300 in a key point detection method according to embodiments of the present disclosure;

FIG. 6 is a flowchart illustrating operation S400 in a key point detection method according to embodiments of the present disclosure;

FIG. 7 is a flowchart illustrating operation S401 in a key point detection method according to embodiments of the present disclosure;

FIG. 8 is another flowchart illustrating a key point detection method according to embodiments of the present disclosure;

FIG. 9 is a flowchart illustrating operation S402 in a key point detection method according to embodiments of the present disclosure;

FIG. 10 shows a flowchart of training a first pyramid neural network in a key point detection method according to embodiments of the present disclosure;

FIG. 11 shows a flowchart of training a second pyramid neural network in a key point detection method according to embodiments of the present disclosure;

FIG. 12 shows a flowchart of training a feature extraction network model in a key point detection method according to embodiments of the present disclosure;

FIG. 13 shows a block diagram of a key point detection apparatus according to embodiments of the present disclosure;

FIG. 14 shows a block diagram of an electronic device 800 according to embodiments of the present disclosure; and

FIG. 15 shows a block diagram of an electronic device 1900 according to embodiments of the present disclosure.

### DETAILED DESCRIPTION

The various exemplary embodiments, features, and aspects of the present disclosure are described below in detail with reference to the accompanying drawings. The same signs in the accompanying drawings represent elements having the same or similar functions. Although the various aspects of the embodiments are illustrated in the accompanying drawings, unless stated particularly, it is not required to draw the accompanying drawings in proportion.

The special word “exemplary” here means “used as examples, embodiments, or descriptions”. Any “exemplary” embodiment given here is not necessarily construed as being superior to or better than other embodiments.

The term “and/or” as used herein merely describes an association relationship between associated objects, indicating that there may be three relationships, for example, A and/or B, which may indicate that A exists separately, both A and B exist, and B exists separately. In addition, the term “at least one” as used herein means any one of multiple elements or any combination of at least two of the multiple elements, for example, including at least one of A, B, or C, which indicates that any one or more elements selected from a set consisting of A, B, and C are included.

In addition, numerous details are given in the following detailed description for the purpose of better explaining the embodiments of the present disclosure. A person skilled in the art should understand that the embodiments of the present disclosure may also be implemented without some specific details. In some examples, methods, means, elements, and circuits well known to a person skilled in the art are not described in detail so as to highlight the subject matter of the embodiments of the present disclosure.

Embodiments of the present disclosure provide a key point detection method. The method may be used to perform key point detection of a human body image, two pyramid network models are used to perform forward processing and reverse processing of multi-scale features of key points, respectively, and more feature information is fused, thereby improving the accuracy of key point position detection.

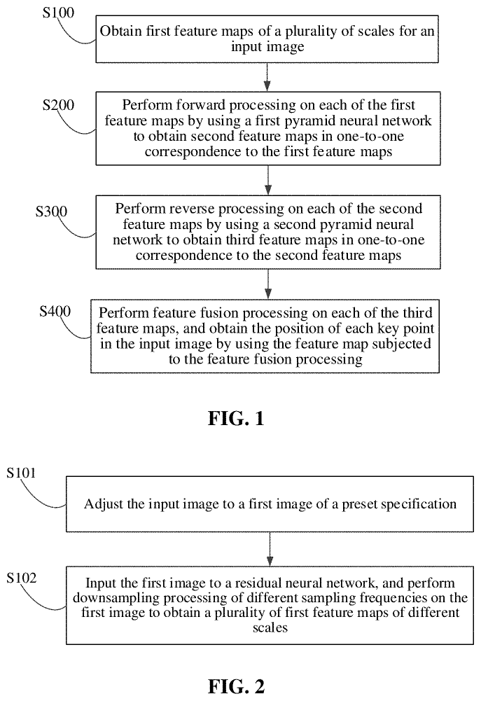

FIG. 1 is a flowchart illustrating a key point detection method according to embodiments of the present disclosure. The key point detection method according to the embodiments of the present disclosure may include the following operations.

At S100, a plurality of first feature maps at a plurality of scales for an input image is obtained, the scales of the plurality of first feature maps being in a multiple relationship.

The embodiments of the present disclosure perform the detection of the foregoing key points in a manner of fusion of multi-scale features of the input image. First, first feature maps of a plurality of scales of the input image may be obtained, and the scales of the first feature maps are different, and the scales are in a multiple relationship. Embodiments of the present disclosure may use a multi-scale analysis algorithm to obtain first feature maps of a plurality of scales for an input image, or may also obtain first feature maps of a plurality of scales for an input image by means of a neural network model capable of performing multi-scale analysis, which is not specifically limited in the embodiments of the present disclosure.

At S200, forward processing is performed on each of the plurality of first feature maps by using a first pyramid neural network to obtain a plurality of second feature maps in one-to-one correspondence to the plurality of first feature maps, where the second feature maps have the same scale as the first feature maps having one-to-one correspondence thereto.

In the embodiments, the forward processing may include first convolution processing and first linear interpolation processing. By means of the forward processing process of the first pyramid neural network, a second feature map having the same scale as the corresponding first feature map may be obtained. Each second feature map further fuses each feature of the input image, and the number of obtained second feature maps is the same as the number of first feature maps, and the second feature maps have the same scale as the corresponding first feature maps. For example, the first feature map obtained in the embodiments of the present disclosure may be C₁, C₂, C₃, and C₄, and the corresponding second feature map obtained after the forward processing may be F₁, F₂, F₃, and F₄. When the scale relationships of the first feature maps C₁ to C₄ are that the scale of C₁ is twice the scale of C₂, the scale of C₂ is twice the scale of C₃, and the scale of C₃ is twice the scale of C₄, in the obtained second feature maps F₁ to F₄, the scale of F₁ is the same as that of C₁, the scale of F₂ is the same as that of C₂, the scale of F₃ is the same as that of C₃, and the scale of F₄ is the same as that of C₄, and the scale of the second feature map F₁ is twice the scale of F₂, the scale of F₂ is twice the scale of F₃, and the scale of F₃ is twice the scale of F₄. The foregoing is only an exemplary description of obtaining the second feature map after the forward processing of the first feature map, and is not a specific limitation of the present disclosure.

At S300, reverse processing is performed on each of the plurality of second feature maps by using a second pyramid neural network to obtain a plurality of third feature maps in one-to-one correspondence to the plurality of second feature maps, where the third feature maps have the same scale as the second feature maps having one-to-one correspondence to the third feature maps.

In the embodiments, the back processing may include second convolution processing and second linear interpolation processing. By means of the reverse processing process of the second pyramid neural network, a third feature map having the same scale as the corresponding second feature map may be obtained. Each third feature map further fuses the feature of the input image with respect to the second feature map, and the number of obtained third feature maps is the same as the number of second feature maps, and the third feature maps have the same scale as the corresponding first feature maps. For example, the second feature map obtained in the embodiments of the present disclosure may be F₁, F₂, F₃, and F₄, and the corresponding third feature map obtained after the reverse processing may be R₁, R₂, R₃, and R₄. When the scale relationships of the second feature maps F₁, F₂, F₃, and F₄ are that the scale of F₁ is twice the scale of F₂, the scale of F₂ is twice the scale of F₃, and the scale of F₃ is twice the scale of F₄, in the obtained third feature maps R₁ to R₄, the scale of R₁ is the same as that of F₁, the scale of R₂ is the same as that of F₂, the scale of R₃ is the same as that of F₃, and the scale of R₃ is the same as that of F₄, and the scale of the third feature map R₁ is twice the scale of R₂, the scale of R₂ is twice the scale of R₃, and the scale of R₃ is twice the scale of R₄. The foregoing is only an exemplary description of obtaining the third feature map after the reverse processing of the second feature map, and is not a specific limitation of the present disclosure.

At S400, feature fusion processing is performed on each of the plurality of third feature maps, and the position of each key point in the input image is obtained by using the feature map subjected to the feature fusion processing.

In the embodiments of the present disclosure, after each of the first feature maps is subjected to forward processing to obtain second feature maps, and third feature maps are obtained according to the reverse processing of the second feature maps, the feature fusion processing of each of the third feature maps may be executed. For example, the embodiments of the present disclosure may implement the feature fusion of each of the third feature maps by using a corresponding convolution processing mode, and may also perform scale transformation when the scales of the third feature maps are different, and then perform splicing of the feature maps, and extraction of key points.

Embodiments of the present disclosure may perform detection of different key points of an input image. For example, when the input image is an image of a person, the key point may be at least one of left and right eyes, nose, left and right ears, left and right shoulders, left and right elbows, left and right wrists, left and right crotches, left and right knees, and left and right ankles. Alternatively, in other embodiments, the input image may also be other types of images, and other key points may be identified when key point detection is performed. Therefore, the embodiments of the present disclosure may further perform detection and identification of key points according to the feature fusion result of the third feature map.

Based on the foregoing configuration, the embodiments of the present disclosure may perform forward processing and further reverse processing based on the first feature maps respectively by means of the bidirectional pyramid neural network (the first pyramid neural network and the second pyramid neural network), which may effectively improve the degree of feature fusion of the input image, thereby further improving the detection accuracy of key points. As shown above, the embodiments of the present disclosure may first obtain an input image, and the input image may be any type of image, such as a person image, a landscape image, and an animal image. For different types of images, different key points may be identified. For example, the embodiments of the present disclosure are described by using the person image as an example. First, the first feature maps of the input image at a plurality of different scales may be obtained by means of operation S100. FIG. 2 is a flowchart illustrating operation S100 in a key point detection method according to embodiments of the present disclosure. The obtaining the first feature maps of different scales for the input image (operation S100) may include the following operations.

At S101, the input image is adjusted to a first image of a preset specification.

The embodiments of the present disclosure may first normalize the size specifications of the input image, that is, the input image may be first adjusted to a first image of a preset specification. The preset specification in the embodiments of the present disclosure may be 256 pix*192 pix, and pix is a pixel value. In other embodiments, the input image may be uniformly converted into images of other specifications, which is not specifically limited in the embodiments of the present disclosure.

At S102, the first image is input to a residual neural network, and downsampling processing at different sampling frequencies is performed on the first image to obtain first feature maps at different scales.

After a first image of a preset specification is obtained, sampling processing of a plurality of sampling frequencies may be performed on the first image. For example, the embodiments of the present disclosure may obtain the first feature maps of different scales for the first image by inputting the first image to a residual neural network and processing by means of the residual neural network. The first image may be sampled by using different sampling frequencies to obtain first feature maps of different scales. The sampling frequency of the embodiments of the present disclosure may be 1/8, 1/16, 1/32, etc., but is not limited in the embodiments of the present disclosure. In addition, the feature map in the embodiments of the present disclosure refers to a feature matrix of an image. For example, the feature matrix in the embodiments of the present disclosure may be a three-dimensional matrix, and the length and width of the feature map described in the embodiments of the present disclosure may be dimensions of the corresponding feature matrix in the row and column directions, respectively.

The first feature maps of the input image obtained after processing in operation S100 are of different scales. Moreover, by controlling the sampling frequency of downsampling, the relationship between the scales of the first feature maps may be L(Cᵢ₋₁)=2^{k}^{₁}·L(Cᵢ) and W(Cᵢ₋₁)=2^{k}^{₁}·W(Cᵢ), where Cᵢ represents each of the first feature maps, L(Cᵢ) represents the length of the first feature map Cᵢ, W(Cᵢ) represents the width of the first feature map Cᵢ, k₁ is an integer greater than or equal to 1, i is a variable, and the range of i is [2, n], and n is the number of first feature maps. That is, the relationship between the length and the width of each first feature map in the embodiments of the present disclosure is both k1-th power times of 2.

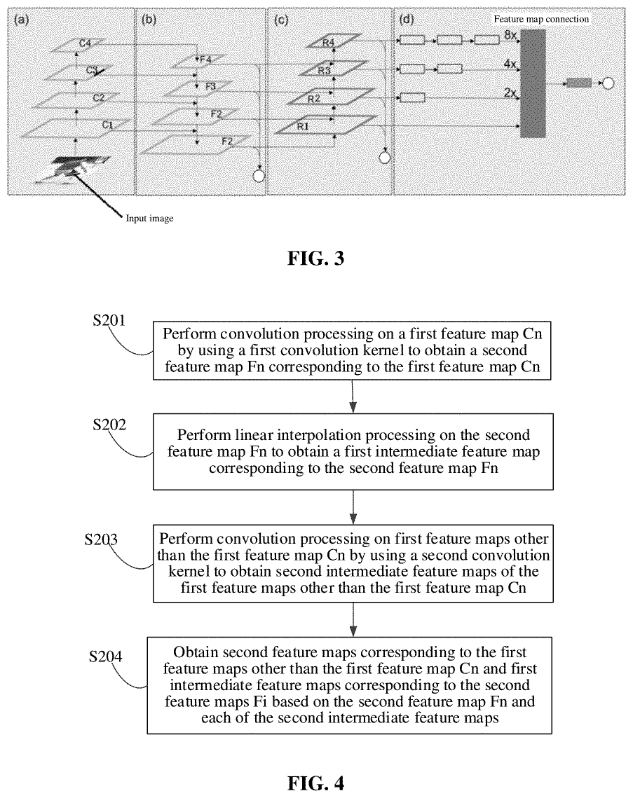

FIG. 3 is another flowchart illustrating a key point detection method according to embodiments of the present disclosure. Part (a) shows the process of operation S100 in the embodiments of the present disclosure, and four first feature maps C₁, C₂, C₃, and C₄ may be obtained by means of operation S100, where the length and width of the first feature map C₁ may be respectively twice the length and width of the first feature map C₂ correspondingly; the length and width of the second feature map C₂ may be respectively twice the length and width of the third feature map C₃ correspondingly; and the length and width of the third feature map C₃ may be respectively twice the length and width of the fourth feature map C₄ correspondingly. In the embodiments of the present disclosure, the scale multiples between C₁ and C₂, between C₂ and C₃, and between C₃ and C₄ may be the same, for example, k₁ takes a value of 1. In other embodiments, k₁ may have different values, for example, the length and width of the first feature map C₁ may be respectively twice the length and width of the first feature map C₂ correspondingly; the length and width of the second feature map C₂ may be respectively quadruple the length and width of the third feature map C₃ correspondingly; and the length and width of the third feature map C₃ may be respectively octuplet the length and width of the fourth feature map C₄ correspondingly. However, the values are not limited in the embodiments of the present disclosure.

After the first feature maps of different scales for the input image are obtained, the forward processing of the first feature map may be performed by means of operation S200 to obtain a plurality of second feature maps of different scales that incorporate the features of each of the first feature maps.

FIG. 4 is a flowchart illustrating operation S200 in a key point detection method according to embodiments of the present disclosure. The performing forward processing on each of the first feature maps by using a first pyramid neural network to obtain second feature maps in one-to-one correspondence to the first feature maps (operation S200) includes the following steps.

At S201, convolution processing is performed on a first feature map Cₙ in first feature maps C₁ . . . Cₙ by using a first convolution kernel to obtain a second feature map Fₙ corresponding to the first feature map Cₙ, where n represents the number of the first feature maps, and n is an integer greater than 1; and the length and width of the first feature map Cₙ are correspondingly the same as the length and width of the second feature map Fₙ, respectively.

The forward processing performed by the first pyramid neural network in the embodiments of the present disclosure may include the first convolution processing and the first linear interpolation processing, and may also include other processing procedures, which are not limited in the embodiments of the present disclosure.

In a possible implementation, the first feature maps obtained in the embodiments of the present disclosure may be C₁ . . . Cₙ, i. e., n first feature maps, and Cₙ may be a feature map with the smallest length and width, that is, a first feature map with the smallest scale. First, convolution processing is performed on the first feature map Cₙ by using the first pyramid neural network, that is, convolution processing is performed on the first feature map Cₙ by using a first convolution kernel to obtain the second feature map Fₙ. The length and width of the second feature map Fₙ are the same as the length and width of the first feature map Cₙ, respectively. The first convolution kernel may be a 3*3 convolution kernel, or may be other type of convolution kernel.

At S202, linear interpolation processing is performed on the second feature map Fₙ to obtain a first intermediate feature map F′ₙ corresponding to the second feature map Fₙ, where the scale of the first intermediate feature map F′ₙ is the same as that of the first feature map Cₙ₋₁.

After the second feature map Fₙ is obtained, a first intermediate feature map Fₙ corresponding thereto may be obtained by using the second feature map Fₙ. Embodiments of the present disclosure may obtain a first intermediate feature map F′ₙ corresponding to the second feature map Fₙ by performing linear interpolation processing on the second feature map Fₙ, where the scale of the first intermediate feature map F′ₙ is the same as the scale of the first feature map Cₙ₋₁. For example, when the scale of Cₙ₋₁ is twice the scale of Cₙ, the length of the first intermediate feature map F′ₙ is twice the length of the second feature map Fₙ, and the width of the first intermediate feature map F′ₙ is twice the width of the second feature map Fₙ.

At S203, convolution processing is performed on first feature maps C₁ . . . Cₙ₋₁ other than the first feature map Cₙ by using a second convolution kernel to obtain second intermediate feature maps C′₁ . . . C′ₙ₋₁ respectively in one-to-one correspondence to the first feature maps C₁ . . . Cₙ₋₁, where the scales of the second intermediate feature maps are the same as those of the first feature maps having one-to-one correspondence thereto.

Moreover, the embodiments of the present disclosure may also obtain second intermediate feature maps C′₁ . . . C′ₙ₋₁ corresponding to the first feature maps C₁ . . . Cₙ₋₁ other than the first feature map Cₙ, where second convolution processing is performed on the first feature maps C₁ . . . Cₙ₋₁ by using a second convolution kernel to obtain second intermediate feature map C′₁ . . . C′ₙ₋₁ respectively corresponding to the first feature maps C₁ . . . Cₙ₋₁, where the second convolution kernel may be a 1*1 convolution kernel, but is not specifically limited in the present disclosure. The scales of the second intermediate feature maps obtained by means of the second convolution processing are the same as the scales of the corresponding first feature maps. In the embodiments of the present disclosure, the second intermediate feature maps C′₁ . . . C′ₙ₋₁ of the first feature map C₁ . . . Cₙ₋₁ may be obtained in an reverse order of the first feature maps C₁ . . . Cₙ₋₁. That is, the second intermediate map C′ₙ₋₁ corresponding to the first feature map Cₙ₋₁ may be obtained first, and then the second intermediate map C′ₙ₋₂ corresponding to the first feature map Cₙ₋₂ may be obtained, and so on, until the second intermediate feature map C′₁ corresponding to the first feature map C₁ is obtained.

At S204, second feature maps F₁ . . . Fₙ₋₁ and first intermediate feature maps F′₁ . . . F′ₙ₋₁ are obtained based on the second feature map Fₙ and each of the second intermediate feature maps C′₁ . . . C′ₙ₋₁, where the second feature map Fᵢ corresponding to the first feature map Cᵢ in the first feature maps C₁ . . . Cₙ₋₁ is obtained by performing superposition processing (summation processing) on the second intermediate feature map C′ᵢ and the first intermediate feature map F′ᵢ₊₁, the first intermediate feature map F′ᵢ is obtained by linear interpolation of the corresponding second feature map Fᵢ, and the second intermediate feature map C′ᵢ has the same scale as the first intermediate feature map F′ᵢ₊₁, where i is an integer greater than or equal to 1 and less than n.

In addition, while each second intermediate feature map is obtained, or after each second intermediate feature map is obtained, first intermediate feature maps F′₁ . . . F′ₙ₋₁ other than the first intermediate feature map F′ₙ may also be correspondingly obtained. In the embodiments of the present disclosure, the second feature map Fᵢ=C′ᵢ+F′ᵢ₊₁ corresponds to the first feature map Cᵢ in the first feature maps C₁ . . . Cₙ₋₁, where the scale (length and width) of the second intermediate feature map C′ᵢ is equal to the scale (length and width) of the first intermediate feature map F′ᵢ₊₁, respectively, and the length and width of the second intermediate feature map are the same as the length and width of the first feature map Cᵢ. Therefore, the length and width of the second feature map Fᵢ obtained are the length and width of the first feature map Cᵢ, respectively. i is an integer greater than or equal to 1 and less than n.

Specifically, in the embodiments of the present disclosure, it is still possible to obtain the second feature maps Fᵢ other than the second feature map Fₙ by using a reverse processing method. That is, in the embodiments of the present disclosure, a first intermediate feature map Fₙ₋₁ may be obtained first, and a second feature map Fₙ₋₁ may be obtained by performing superposition processing on the second intermediate map C′ₙ₋₁ corresponding to the first feature map Cₙ₋₁ and the first intermediate feature map F′ₙ, where the length and width of the second intermediate feature map C′ₙ₋₁ are respectively the same as the length and width of the first intermediate feature map F′ₙ, and the length and width of the second feature map Fₙ₋₁ are the length and width of the second intermediate feature map C′ₙ₋₁ and F′ₙ. In this case, the length and width of the second feature map Fₙ₋₁ are respectively twice the length and width of the second feature map Fₙ (the scale of Cₙ₋₁ is twice the scale of Cₙ). Further, linear interpolation processing may be performed on the second feature map Fₙ₋₁ to obtain a first intermediate feature map F′ₙ₋₁, so that the scale of F′ₙ₋₁ is the same as the scale of Cₙ₋₁, and then the second feature map Fₙ₋₂ is obtained by performing superposition processing on the second intermediate feature map C′ₙ₋₂ corresponding to the first feature map Cₙ₋₂ and the first intermediate feature map F′ₙ₋₁, where the length and width of the second intermediate feature map C′ₙ₋₂ are respectively the same as the length and width of the first intermediate feature map F′ₙ₋₁, and the length and width of the second feature map Fₙ₋₂ are the length and width of the second intermediate feature map C′ₙ₋₂ and F′ₙ₋₁. For example, the length and width of the second feature map Fₙ₋₂ are twice the length and width of the second feature map Fₙ₋₁, respectively. In this way, the first intermediate feature map F′₂ may be finally obtained, and the second feature map F₁ is obtained according to the superposition processing of the first intermediate feature map F′₂ and the first feature map C′₁. The length and width of F₁ are the same as the length and width of C₁, respectively. Thus, each second feature map is obtained, and satisfies L(Fᵢ₋₁)=2^{k}^{₁}·L(Fᵢ)A and W(Fᵢ₋₁)=2^{k}^{₁}·W(Fᵢ), and L(Fₙ)=L(Cₙ), and W(Fₙ)=W(Cₙ).

For example, the above four first feature maps C₁, C₂, C₃, and C₄ are taken as an example for description. As shown in FIG. 3, in operation S200, a first Feature Pyramid Network (FPN) may be used to obtain a multi-scale second feature map. First, a new feature map F₄ (second feature map) may be obtained by calculating C₄ with one 3*3 first convolution kernel, and the length and width of F₄ are the same as those of C₄. An upsampling operation of double linear interpolation is performed on F₄ to obtain a feature map with both the length and the width doubled, i. e., the first intermediate feature map F′₄. One second intermediate feature map C′₃ is obtained by calculating C₃ with one 1*1 second convolution kernel, C′₃ and F′₄ are the same in size, and the two feature maps are added to obtain a new feature map F₃ (second feature map), so that the length and width of the second feature map F₃ are respectively twice those of the second feature map F₄. An upsampling operation of double linear interpolation is performed on F₃ to obtain a feature map with both the length and the width doubled, i. e., the first intermediate feature map F′₃. One second intermediate feature map C′₂ is obtained by calculating C₂ with one 1*1 second convolution kernel, C′₂ and F′₃ are the same in size, and the two feature maps are added to obtain a new feature map F₂ (second feature map), so that the length and width of the second feature map F₂ are respectively twice those of the second feature map F₃. An upsampling operation of double linear interpolation is performed on F₂ to obtain a feature map with both the length and the width doubled, i. e., the first intermediate feature map F′₂. One second intermediate feature map C′₁ is obtained by calculating C₁ with one 1*1 second convolution kernel, C′₁ and F′₂ are the same in size, and the two feature maps are added to obtain a new feature map F₂ (second feature map), so that the length and width of the second feature map F₁ are respectively twice those of the second feature map F₂. After passing through the FPN, four second feature maps of different scales are also obtained, which are respectively annotated as F₁, F₂, F₃, and F₄. Moreover, the multiples of the length and width between F₁ and F₂ are the same as the multiples of the length and width between C₁ and C₂, the multiples of the length and width between F₂ and F₃ are the same as the multiples of the length and width between C₂ and C₃, and the multiples of the length and width between F₃ and F₄ are the same as the multiples of the length and width between C₃ and C₄.

After the foregoing forward processing of the pyramid network model, more features may be fused in each second feature map. In order to further improve the accuracy of feature extraction, the embodiments of the present disclosure also perform reverse processing on each second feature map by using a second pyramid neural network after operation S200. The reverse processing may include second convolution processing and second linear interpolation processing, and may also include other processing, which is not specifically limited in the embodiments of the present disclosure.

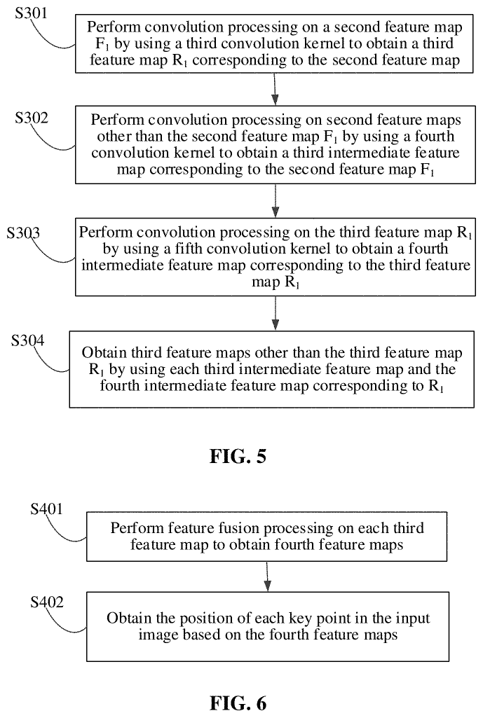

FIG. 5 is a flowchart illustrating operation S300 in a key point detection method according to embodiments of the present disclosure. The performing reverse processing on each of the second feature maps by using a second pyramid neural network to obtain third feature maps Rᵢ of different scales (operation S300) may include the following steps.

At S301, convolution processing is performed on a second feature map F₁ in second feature maps F₁ . . . Fₘ by using a third convolution kernel to obtain a third feature map R₁ corresponding to the second feature map F₁, where the length and width of the third feature map R₁ are respectively the same as the length and width of the first feature map C₁, m represents the number of the second feature maps, and m is an integer greater than 1. In this case, m is the same as the number n of the first feature maps.

In the process of reverse processing, reverse processing may be first performed on the second feature map F₁ with the largest length and width. For example, reverse processing may be performed on the second feature map F₁ by means of a third convolution kernel to obtain a third intermediate feature map R₁ with the length and width the same as those of F₁. The third convolution kernel may be a 3*3 convolution kernel, or may be other types of convolution kernels. The required convolution kernel may be selected according to different requirements in the technical field in the art.

At S302, convolution processing is performed on second feature maps F₂ . . . Fₘ by using a fourth convolution kernel to respectively obtain corresponding third intermediate feature maps F″₂ . . . F″ₘ, where the scales of the third intermediate feature maps are the same as those of the corresponding second feature maps.

After obtaining the third feature map R₁, convolution processing may be performed on each of the second feature maps F₂ . . . Fₘ other than the second feature map F₁ by using a fourth convolution kernel to obtain corresponding third intermediate feature maps F″₁ . . . F″ₘ₋₁. In operation S302, convolution processing may be performed on the second feature maps F₂ . . . Fₘ other than the second feature map F₁ by means of the fourth convolution kernel, where convolution processing may be first performed on F₂ to obtain a corresponding third intermediate feature map F″₂, and then convolution processing is performed on F₃ to obtain a corresponding third intermediate feature map F″₃, and so on, to obtain a third intermediate feature map F″ₙ corresponding to the second feature map Fₘ. In the embodiments of the present disclosure, the length and width of each third intermediate feature map F″ⱼ may be the length and width of the corresponding second feature map Fⱼ.

At S303, convolution processing is performed on the third feature map R₁ by using a fifth convolution kernel to obtain a fourth intermediate feature map R′₁ corresponding to the third feature map R₁.

After obtaining the third feature map R₁, convolution processing may be performed on each of the second feature maps F₂ . . . Fₘ other than the second feature map F₁ by using a fourth convolution kernel to obtain corresponding third intermediate feature maps F″₁ . . . F″ₘ₋₁. In operation S302, convolution processing may be performed on the second feature maps F₂ . . . Fₘ other than the second feature map F₁ by means of the fourth convolution kernel, where convolution processing may be first performed on F₂ to obtain a corresponding third intermediate feature map F″₂, and then convolution processing is performed on F₃ to obtain a corresponding third intermediate feature map F″₃, and so on, to obtain a third intermediate feature map F″ₙ corresponding to the second feature map Fₘ. In the embodiments of the present disclosure, the length and width of each third intermediate feature map F″ⱼ may be half the length and width of the corresponding second feature map Fⱼ.

At S304, third feature maps R₂ . . . Rₘ are obtained by using each of the third intermediate feature maps F″₂ . . . F″ₘ and the fourth intermediate feature map R′₁, where a third feature map Rⱼ is obtained by superposition processing of a third intermediate feature map F″ⱼ and a fourth intermediate feature map R′ⱼ₋₁, and the fourth intermediate feature map R′ⱼ₋₁ is obtained by performing convolution processing on a corresponding third feature map Rⱼ₋₁ using a fifth convolution kernel, where j is greater than 1 and less than or equal to m.

After performing operation S301 or after performing operation S302, convolution processing may also be performed on the third feature map R₁ by using a fifth convolution kernel to obtain a fourth intermediate feature map R′₁ corresponding to the third feature map R₁. The length and width of the fourth intermediate feature map R′₁ are the length and width of the second feature map F₂.

In addition, the third intermediate feature map F″ᵢ obtained in operation S302 and the fourth intermediate feature map R′₁ obtained in operation S303 may also be used to obtain third feature maps R₂ . . . Rₘ other than the third feature map R₁. The third feature maps R₂ . . . Rₘ other than the third feature map R₁ are obtained by superposition processing of the third intermediate feature map F″ⱼ and the fourth intermediate feature map R′ⱼ₋₁.

Specifically, in operation S304, superposition processing may be separately performed on the corresponding third intermediate feature map F″ᵢ and the fourth intermediate feature map R′ᵢ₋₁ to obtain third feature maps Rⱼ other than the third feature map R₁. The third feature map R₂ may be obtained by means of a summation result of the third intermediate feature map F″₂ and the fourth intermediate feature map R′₁. Then, convolution processing is performed on R₂ by using the fifth convolution kernel to obtain a fourth intermediate feature map R′₂, and a third feature map R₃ is obtained by means of a summation result of the third intermediate feature map F″₃ and the fourth intermediate feature map R′₂. In this way, the remaining fourth intermediate feature maps R′₃ . . . R′ₘ and the third feature maps R₄ . . . Rₘ may be further obtained.

In addition, in the embodiments of the present disclosure, the length and width of each fourth intermediate feature map R′₁ obtained may be the same as the length and width of the second feature map F₂, respectively. Moreover, the length and width of the fourth intermediate feature map R′ⱼ are the same as the length and width of the fourth intermediate feature map F″ⱼ₊₁, respectively. Thus, the length and width of the obtained third feature map Rⱼ are respectively the length and width of the second feature map Fᵢ, and further, the length and width of each of the third feature maps R₁ . . . Rn are respectively equal to the first feature maps C₁ . . . Cₙ, correspondingly.

The following example illustrates the process of reverse processing. As shown in FIG. 3, a second Reverse Feature Pyramid Network (RFPN) is then used to further optimize multi-scale features. The second feature map F₁ is subjected to one 3*3 convolution kernel (third convolution kernel) to obtain a new feature map R₁ (the third feature map). The length and width of R₁ are the same as those of F₁. The feature map R₁ is calculated by one 3*3 convolution kernel (the fifth convolution kernel) with a stride of 2 to obtain a new feature map, annotated as R′₁. The length and width of R′₁ may be half of R₁. The second feature map F₂ is calculated by one 3*3 convolution kernel (the fourth convolution kernel) to obtain a new feature map, annotated as F″₂. R′₁ is the same as F″₂ in size, and R′₁ is added to F″₂ to obtain a new feature map R₂. The operations of R₁ and F₂ are repeated on R₂ and F₃ to obtain a new feature map R₃. The operations of R₁ and F₂ are repeated on R₃ and F₄ to obtain a new feature map R₄. After passing through the FPN, four second feature maps of different scales are also obtained, which are respectively annotated as R₁, R₂, R₃, and R₄. Similarly, the multiples of the length and width between R₁ and R₂ are the same as the multiples of the length and width between C₁ and C₂, the multiples of the length and width between R₂ and R₃ are the same as the multiples of the length and width between R₂ and R₃, and the multiples of the length and width between R₃ and R₄ are the same as the multiples of the length and width between C₃ and C₄.

Based on the foregoing configuration, the third feature maps R₁ . . . Rn obtained by means of reverse processing of the second pyramid model may be obtained. The forward processing and the reverse processing may further improve the characteristics of image fusion. The feature points may be accurately identified based on the third feature maps.

After operation S300, the position of each key point of the input image may be obtained according to the feature fusion result of each third feature map Rᵢ. FIG. 6 is a flowchart illustrating operation S400 in a key point detection method according to embodiments of the present disclosure. The performing feature fusion processing on each of the third feature maps, and obtaining the position of each key point in the input image by using the feature map subjected to the feature fusion processing (operation S400) may include the following steps.

At S401, feature fusion processing is performed on each of the plurality of third feature maps to obtain a fourth feature map.

In the embodiments of the present disclosure, after the third feature maps R₁ . . . Rₙ of different scales are obtained, feature fusion may be performed on each third feature map. Since the length and width of each third feature map in the embodiments of the present disclosure are different, the linear interpolation processing may be performed on R₂ . . . Rₙ, respectively, so that the length and width of each third feature map R₂ . . . Rₙ are the same as the length and width of the third feature map R₁. The processed third feature maps may then be combined to form fourth feature maps.

At S402, the position of each key point in the input image is obtained based on the fourth feature map.

After the fourth feature map is obtained, the dimension reduction processing is performed on the fourth feature map. For example, dimension reduction may be performed on the fourth feature map by means of convolution processing, and the positions of feature points of the input image may be identified using the feature map subjected to the dimension reduction.

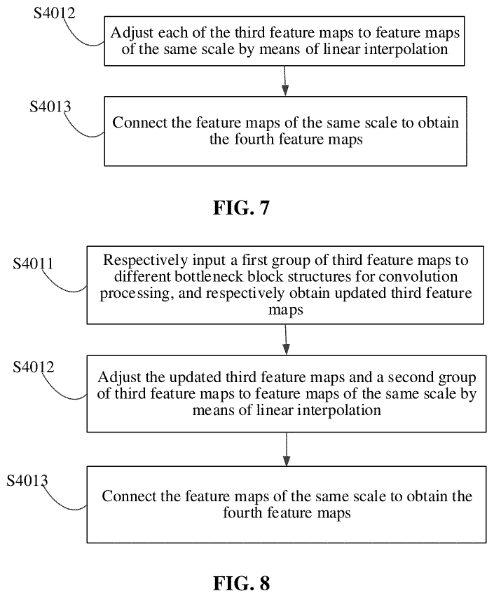

FIG. 7 is a flowchart illustrating operation S401 in a key point detection method according to embodiments of the present disclosure. The performing feature fusion processing on each of the third feature maps to obtain fourth feature maps (operation S401) may include the following steps.

At S4012, each of the plurality of third feature maps is adjusted to feature maps of the same scale by means of linear interpolation.

Since the scales of the third feature maps R₁ . . . Rₙ obtained in the embodiments of the present disclosure are different, it is necessary to first adjust the third feature maps to feature maps of the same scale. In the embodiments of the present disclosure, different linear interpolation processing may be performed on the third feature maps, so that the scales of the feature maps are the same, and the multiples of the linear interpolation may be related to the scale multiples between the third feature maps.

At S4013, the feature maps subjected to the linear interpolation processing are connected to obtain a fourth feature map.

After obtaining the feature maps of the same scale, the feature maps may be spliced and combined to obtain fourth feature maps. For example, the length and width of the feature maps subjected to the interpolation processing in the embodiments of the present disclosure are the same. The fourth feature maps are obtained by connecting the feature maps in the height direction. For example, each feature map processed by S4012 may be expressed as A, B, C, and D, and the obtained fourth feature map may be

$$[ \begin{matrix}A \\ B \\ C \\ D\end{matrix} ] .$$

In addition, before operation S401, in order to optimize small-scale features, the embodiments of the present disclosure may further optimize the third feature map with a smaller length and width, and may further perform convolution processing on part of the features.

FIG. 8 is another flowchart illustrating a key point detection method according to embodiments of the present disclosure. Before the performing feature fusion processing on each of the third feature maps to obtain fourth feature maps, the method may further include S4011. At S4011, a first group of third feature maps is respectively input to different bottleneck block structures for convolution processing, and updated third feature maps are respectively obtained, each of the bottleneck block structures including a different number of convolution modules, where the third feature map includes a first group of third feature maps and a second group of third feature maps, and the first group of third feature maps and the second group of third feature maps each include at least one third feature map.

As described above, in order to optimize the features in the small-scale feature maps, further convolution processing may be performed on the small-scale feature maps, where the third feature maps R₁ . . . Rₘ may be divided into two groups. The scale of the first group of third feature maps is smaller than the scale of the second group of third feature maps. Accordingly, each third feature map in the first group of third feature maps may be respectively input into different bottleneck block structures to obtain the updated third feature maps. The bottleneck block structure may include at least one convolution module. The number of convolution modules in different bottleneck block structures may be different, where the size of the feature map obtained after the convolution processing of the bottleneck block structure is the same as the size of the third feature map before input.

The first group of third feature maps may be determined according to a preset ratio of the number of third feature maps. For example, the preset ratio may be 50%, that is, half of the third feature maps with a smaller size in the third feature maps may be input as a first group of third feature maps into different bottleneck block structures for feature optimization processing. The preset ratio may also be other ratio values, which is not limited in the present disclosure. Alternatively, in some other possible embodiments, the first group of third feature maps input to the bottleneck block structure may also be determined according to a scale threshold. Feature maps smaller than the scale threshold are determined to be input into the bottleneck block structure for feature optimization processing. The scale threshold may be determined according to the scale of each feature map, which is not specifically limited in the embodiments of the present disclosure.

In addition, the selection of the bottleneck block structure is not specifically limited in the embodiments of the present disclosure, and the form of the convolution module may be selected according to requirements.

At S4012, the updated third feature maps and the second group of third feature maps are adjusted to feature maps of the same scale by means of linear interpolation.

After operation S4011 is performed, the optimized first group of third feature maps and the second group of third features may be scale-normalized, that is, each feature map is adjusted to a feature map of the same size. The embodiments of the present disclosure perform corresponding linear interpolation processing on each third feature map and the second group of third feature maps optimized in S4011, respectively, thereby obtaining feature maps of the same size.

In the embodiments of the present disclosure, as shown in part (d) of FIG. 3, in order to optimize small-scale features, R₂, R₃, and R₄ are followed by a different number of bottleneck block structures. R₂ is followed by one bottleneck block to obtain a new feature map, annotated as R″₂. R₃ is followed by two bottleneck blocks to obtain a new feature map, annotated as R″₄. R₄ is followed by three bottleneck blocks to obtain a new feature map, annotated as R″₄. In order to perform fusion, the sizes of the four feature maps R₁, R″₂, R″₃, and R″₄ need to be unified. Therefore, R″₂ is doubled by means of the upsampling operation of double linear interpolation, to obtain the feature map R′″₂. R″₃ is quadrupled by means of the upsampling operation of double linear interpolation, to obtain the feature map R′″₃. R″₄ is octupled by means of the upsampling operation of double linear interpolation, to obtain the feature map R′″₄. In this case, R₁, R″₂, R″₃, and R″₄ are the same in scale.

At S4013, the feature maps of the same scale are connected to obtain the fourth feature maps.

After operation S4012, feature maps of the same scale may be connected. For example, the above four feature maps are connected to obtain a new feature map, i. e., the fourth feature map. For example, the four feature maps R₁, R″₂, R″₃, and R″₄ are all 256-dimension, and the obtained fourth feature map may be 1024-dimension.

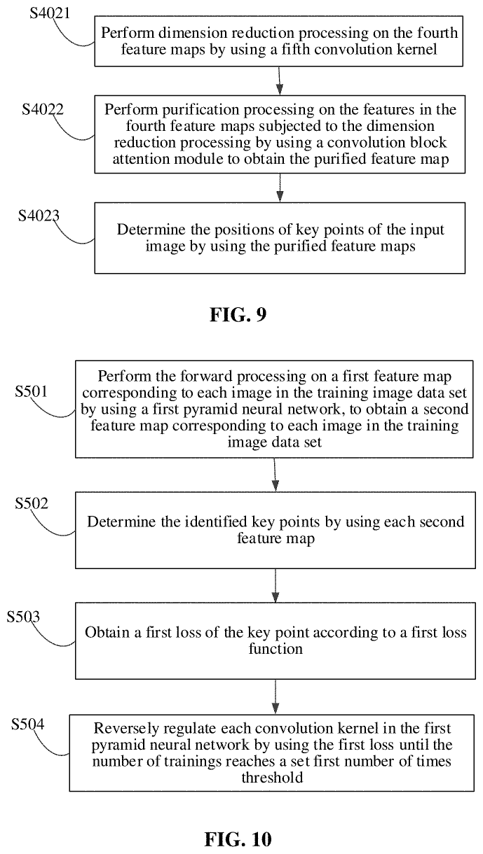

The corresponding fourth feature map may be obtained by means of the configurations in the different embodiments above. After the fourth feature map is obtained, the positions of the key points of the input image may be obtained according to the fourth feature map. Dimension reduction processing may be directly performed on the fourth feature map, and the positions of key points of the input image may be determined by using the feature map subjected to the dimension reduction processing. In some other embodiments, the feature map subjected to the dimension reduction processing may also be purified to further improve the accuracy of key points. FIG. 9 is a flowchart illustrating operation S402 in a key point detection method according to embodiments of the present disclosure. The obtaining the position of each key point in the input image based on the fourth feature maps may include the following steps.

At S4021, dimension reduction processing is performed on the fourth feature maps by using a fifth convolution kernel.

In the embodiments of the present disclosure, the mode for performing the dimension reduction processing may be convolution processing, that is, convolution processing is performed on the fourth feature map by using a preset convolution module, so as to achieve the dimension reduction of the fourth feature map to obtain, for example, 256-dimension feature map.

At S4022, purification processing is performed on the features in the fourth feature maps subjected to the dimension reduction processing by using a convolution block attention module to obtain the purified feature map.

Then, the fourth feature map subjected to the dimension reduction processing may be further purified by using the convolution block attention module. The convolution block attention module may be a convolution block attention module in the prior art. For example, the convolution block attention module in the embodiments of the present disclosure may include a channel attention unit and an importance attention unit. The fourth feature map subjected to the dimension reduction processing may be first input to the channel attention unit, where the fourth feature map subjected to the dimension reduction processing may be first subjected to global max pooling and global average pooling based on the height and width, and then a first result obtained by global max pooling and a second result obtained by global average pooling are input into the Multi-Layer Perceptron (MLP), and the two results subjected to the MLP processing are summed to obtain a third result, and the third result is activated to obtain the channel attention feature map.

After the channel attention feature map is obtained, the channel attention feature map is input to the importance attention unit. First, the channel attention feature map may be input to the channel-based global max pooling and global average pooling, to obtain a fourth result and a fifth result, respectively, and then the fourth result and the fifth result are connected, and then dimension reduction is performed on the connected result by means of convolution processing, the dimension reduction result is processed by using a sigmoid function to obtain an importance attention feature map, and then the importance attention feature map and the channel attention feature map are multiplied to obtain a purified feature map. The above is only an exemplary description of the convolution block attention module in the embodiments of the present disclosure. In other embodiments, other structures may also be used to perform purification processing on the fourth feature map subjected to the dimension reduction.

At S4023, the positions of the key points of the input image are determined by using the purified feature maps.

After the purified feature map is obtained, the position information of key points is obtained by using the feature map. For example, the purified feature map is input to a 3*3 convolution module to predict the position information of each key point in the input image. When the input image is a facial image, the predicted key points may be the positions of 17 key points, for example, the positions of left and right eyes, nose, left and right ears, left and right shoulders, left and right elbows, left and right wrists, left and right crotches, left and right knees, and left and right ankles. In other embodiments, the positions of other key points may also be obtained, which is not limited in the embodiments of the present disclosure.

Based on the above configuration, the features may be more fully fused by means of the forward processing of the first pyramid neural network and the reverse processing of the second pyramid neural network, thereby improving the detection accuracy of key points.

In the embodiments of the present disclosure, training of the first pyramid neural network and the second pyramid neural network may also be performed, so that the forward processing and the reverse processing satisfy the operation accuracy. FIG. 10 is a flowchart of training a first pyramid neural network in a key point detection method according to embodiments of the present disclosure. In the embodiments of the present disclosure, the training the first pyramid neural network by using a training image data set includes the following operations.

At S501, the forward processing is performed on a first feature map corresponding to each image in the training image data set by using the first pyramid neural network, to obtain a second feature map corresponding to each image in the training image data set.

In the embodiments of the present disclosure, the training image data set may be input to the first pyramid neural network for training The training image data set may include a plurality of images and the real positions of key points corresponding to the images. The first pyramid network may be used to perform steps S100 and S200 (extraction and forward processing of the multi-scale first feature maps) as described above to obtain the second feature map of each image.

At S502, the identified key points are determined by using each second feature map.

After operation S201, the key points of the training image may be identified by using the obtained second feature map to obtain the first position of each key point of the training image.

At S503, a first loss of the key point is obtained according to a first loss function.

At S504, each convolution kernel in the first pyramid neural network is reversely regulated by using the first loss until the number of trainings reaches a set first number of times threshold.

Accordingly, after the first position of each key point is obtained, a first loss corresponding to the predicted first position may be obtained. During the training process, the parameters of the first pyramid neural network, such as the parameters of the convolution kernel, may be reversely regulated according to the first loss obtained from each training until the number of training times reaches the first number of times threshold, which may be set according to requirements, and is generally a value greater than 120. For example, the first number of times threshold in the embodiments of the present disclosure may be 140.

The first loss corresponding to the first position may be a loss value obtained by inputting a first difference between the first position and the real position into a first loss function, where the first loss function may be a logarithmic loss function. Alternatively, the first position and the real position may also be input to a first loss function to obtain a corresponding first loss. The embodiments of the present disclosure do not limit the above conditions. Based on the above, the training process of the first pyramid neural network may be realized, and the optimization of the parameters of the first pyramid neural network may be realized.

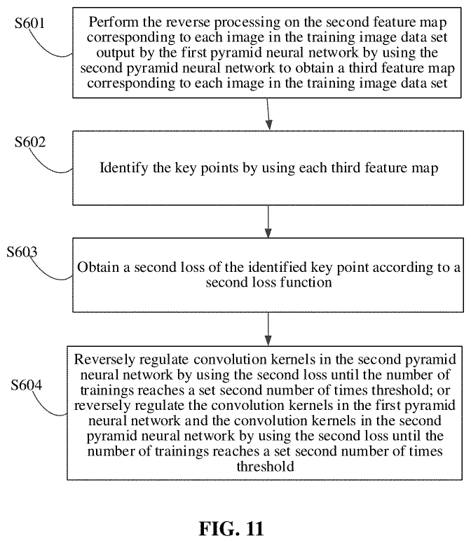

In addition, accordingly, FIG. 11 shows a flowchart of training a second pyramid neural network in a key point detection method according to embodiments of the present disclosure. In the embodiments of the present disclosure, the training the second pyramid neural network by using a training image data set includes the following operations.

At S601, the reverse processing is performed on the second feature map corresponding to each image in the training image data set output by the first pyramid neural network by using the second pyramid neural network to obtain a third feature map corresponding to each image in the training image data set.

At S602, the key points are identified by using each third feature map.

In the embodiments of the present disclosure, the second feature map of each image in the training image data set may be first obtained by using the first pyramid neural network, and then the reverse processing is performed on the second feature map corresponding to each image in the training image data set by means of the second pyramid neural network, to obtain a third feature map corresponding to each image in the training image data set, and then the second position of the key point of the corresponding image is predicted by using the third feature map.

At S603, a second loss of the identified key point is obtained according to a second loss function.

At S604, convolution kernels in the second pyramid neural network are reversely regulated by using the second loss until the number of trainings reaches a set second number of times threshold; or the convolution kernels in the first pyramid neural network and the convolution kernels in the second pyramid neural network are reversely regulated by using the second loss until the number of trainings reaches a set second number of times threshold.

Accordingly, after the second position of each key point is obtained, a second loss corresponding to the predicted second position may be obtained. During the training process, the parameters of the second pyramid neural network, such as the parameters of the convolution kernel, may be reversely regulated according to the second loss obtained from each training until the number of training times reaches the second number of times threshold, which may be set according to requirements, and is generally a value greater than 120. For example, the second number of times threshold in the embodiments of the present disclosure may be 140.

The second loss corresponding to the second position may be a loss value obtained by inputting a second difference between the second position and the real position into a second loss function, where the second loss function may be a logarithmic loss function. Alternatively, the second position and the real position may also be input to a second loss function to obtain a corresponding second loss value. The embodiments of the present disclosure do not limit the above conditions.

In some other embodiments of the present disclosure, while training the second pyramid neural network, the first pyramid neural network may be further optimized and trained simultaneously, that is, in the embodiments of the present disclosure, in operation S604, the parameters of the convolution kernel in the first pyramid neural network and the parameters of the convolution kernel in the second pyramid neural network may be reversely regulated by using the obtained second loss value simultaneously. Thus, further optimization of the entire network model is achieved.

Based on the above, in the training process of the second pyramid neural network, and the optimization of the first pyramid neural network may be realized.

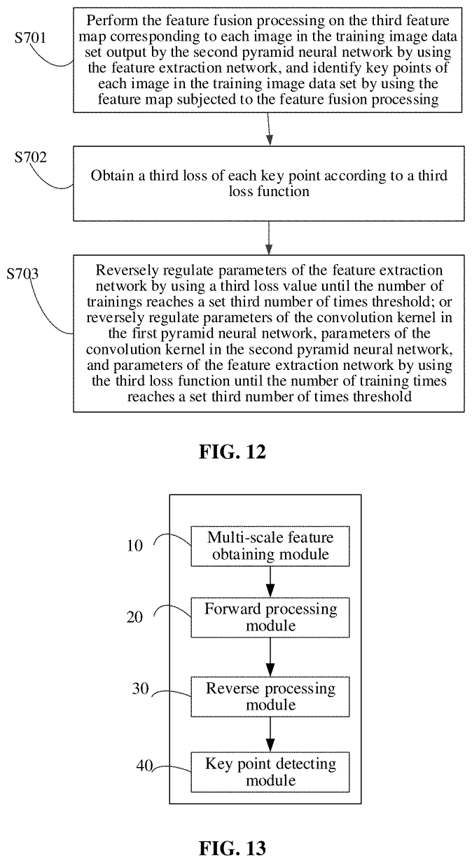

In addition, in the embodiments of the present disclosure, operation S400 may be implemented by means of a feature extraction network model. The embodiments of the present disclosure may also perform an optimization process of the feature extraction network model. FIG. 12 shows a flowchart of training a feature extraction network model in a key point detection method according to embodiments of the present disclosure, where the training the feature extraction network model by using a training image data set may include the following operations.

At S701, the feature fusion processing is performed on the third feature map corresponding to each image in the training image data set output by the second pyramid neural network by using the feature extraction network, and key points of each image in the training image data set are identified by using the feature map subjected to the feature fusion processing.

In the embodiments of the present disclosure, the third feature map corresponding to the training image data set and processed by the first pyramid neural network forward processing and the second pyramid neural network processing may be input to a feature extraction network model, feature fusion, purification and the like are performed by means of the feature extraction network to obtain the third positions of the key points of each image in the training image data set.

At S702, a third loss of each key point is obtained according to a third loss function.

At S703, parameters of the feature extraction network are reversely regulated by using a third loss value until the number of trainings reaches a set third number of times threshold; or parameters of the convolution kernel in the first pyramid neural network, parameters of the convolution kernel in the second pyramid neural network, and parameters of the feature extraction network are reversely regulated by using the third loss function until the number of training times reaches a set third number of times threshold.

Accordingly, after the third position of each key point is obtained, a third loss corresponding to the predicted third position may be obtained. During the training process, the parameters of the feature extraction network model, such as the parameters of the convolution kernel or parameters of the process such as pooling, may be reversely regulated according to the third loss obtained from each training until the number of training times reaches the third number of times threshold, which may be set according to requirements, and is generally a value greater than 120. For example, the third number of times threshold in the embodiments of the present disclosure may be 140.

The third loss corresponding to the third position may be a loss value obtained by inputting a third difference between the third position and the real position into a third loss function, where the third loss function may be a logarithmic loss function. Alternatively, the third position and the real position may also be input to a third loss function to obtain a corresponding third loss value. The embodiments of the present disclosure do not limit the above conditions.

Based on the above, the training process of the feature extraction network model may be realized, and the parameters of the feature extraction network model may be optimized.

In some other embodiments of the present disclosure, while training the feature extraction network, the first pyramid neural network and the second pyramid neural network may be further optimized and trained simultaneously, that is, in the embodiments of the present disclosure, in operation S703, the parameters of the convolution kernel in the first pyramid neural network, the parameters of the convolution kernel in the second pyramid neural network, and the parameters of the feature extraction network model may be reversely regulated by using the obtained third loss value simultaneously, so as to realize further optimization of the entire network model.

In view of the above, the embodiments of the present disclosure provide a method for performing key point feature detection by using a bidirectional pyramid neural network, in which not only multi-scale features are obtained by using forward processing, but also more features are merged by using reverse processing, thereby further improving the detection accuracy of key points.

A person skilled in the art can understand that, in the foregoing methods of the specific implementations, the order in which the steps are written does not imply a strict execution order which constitutes any limitation to the implementation process, and the specific order of executing the steps should be determined by functions and possible internal logics thereof.

It can be understood that the foregoing various method embodiments mentioned in the present disclosure may be combined with each other to form a combined embodiment without departing from the principle logic. Details are not described herein repeatedly due to space limitation.

In addition, the present disclosure further provides a key point detection apparatus, an electronic device, a computer-readable storage medium, and a program, which may all be configured to implement any one of the key point detection methods provided in the present disclosure. For corresponding technical solutions and descriptions, please refer to the corresponding content in the method section. Details are not described repeatedly.

FIG. 13 shows a block diagram of a key point detection apparatus according to embodiments of the present disclosure. As shown in FIG. 13, the key point detection apparatus includes:

a multi-scale feature obtaining module 10, configured to obtain a plurality of first feature maps at a plurality of scales for an input image, the scales of the plurality of first feature maps being in a multiple relationship; a forward processing module 20, configured to perform forward processing on each of the plurality of first feature maps by using a first pyramid neural network to obtain a plurality of second feature maps in one-to-one correspondence to the plurality of first feature maps, where the plurality of second feature maps have the same scale as the plurality of first feature maps having one-to-one correspondence thereto; a reverse processing module 30, configured to perform reverse processing on each of the plurality of second feature maps by using a second pyramid neural network to obtain a plurality of third feature maps in one-to-one correspondence to the plurality of second feature maps, where the plurality of third feature maps have the same scale as the plurality of second feature maps having one-to-one correspondence thereto; and a key point detecting module 40, configured to perform feature fusion processing on each of the plurality of third feature maps, and obtain the position of each key point in the input image by using the feature map subjected to the feature fusion processing.

In some possible implementations, the multi-scale feature obtaining module is configured to adjust the input image to a first image of a preset specification; and input the first image to a residual neural network, and perform downsampling processing at different sampling frequencies on the first image to obtain a plurality of first feature maps of different scales.

In some possible implementations, the forward processing includes first convolution processing and first linear interpolation processing, and the reverse processing includes second convolution processing and second linear interpolation processing.

In some possible implementations, the forward processing module is configured to perform convolution processing on a first feature map C₁ . . . Cₙ in first feature maps Cₙ by using a first convolution kernel to obtain a second feature map Cₙ corresponding to the first feature map Fₙ, where n represents the number of the first feature maps, and n is an integer greater than 1; perform linear interpolation processing on the second feature map Fₙ to obtain a first intermediate feature map Fₙ corresponding to the second feature map F′ₙ, where the scale of the first intermediate feature map F′ₙ is the same as that of the first feature map Cₙ₋₁; perform convolution processing on first feature maps Cₙ other than the first feature map C₁ . . . Cₙ₋₁ by using a second convolution kernel to obtain second intermediate feature maps C₁ . . . Cₙ₋₁ respectively in one-to-one correspondence to the first feature maps C′₁ . . . C′ₙ₋₁, where the scales of the second intermediate feature maps are the same as those of the first feature maps having one-to-one correspondence thereto; and obtain second feature maps Fₙ and first intermediate feature maps C′₁ . . . C′ₙ₋₁ based on the second feature map F₁ . . . Fₙ₋₁ and each of the second intermediate feature maps F′₁ . . . F′ₙ₋₁, where the second feature map Fᵢ is obtained by performing superposition processing on the second intermediate feature map C′ᵢ and the first intermediate feature map F′ᵢ₊₁, the first intermediate feature map F′ᵢ is obtained by linear interpolation of the corresponding second feature map Fᵢ, and the second intermediate feature map C′ᵢ has the same scale as the first intermediate feature map F′ᵢ₊₁, where i is an integer greater than or equal to 1 and less than n.

In some possible implementations, the reverse processing module is configured to perform convolution processing on a second feature map F₁ . . . Fₘ in second feature maps F₁ by using a third convolution kernel to obtain a third feature map F₁ corresponding to the second feature map R₁, where m represents the number of the second feature maps, and m is an integer greater than 1; perform convolution processing on second feature maps F₂ . . . Fₘ by using a fourth convolution kernel to respectively obtain corresponding third intermediate feature maps F″₂ . . . F″ₘ, where the scales of the third intermediate feature maps are the same as those of the corresponding second feature maps; perform convolution processing on the third feature map R₁ by using a fifth convolution kernel to obtain a fourth intermediate feature map R₁ corresponding to the third feature map R′₁; and obtain third feature maps F″₂ . . . F″ₘ and fourth intermediate feature maps R′₁ by using the third intermediate feature maps R₂ . . . Rₘ and the fourth intermediate feature map R′₂ . . . R′ₘ, where a third feature map Rⱼ is obtained by superposition processing of a third intermediate feature map F″ⱼ and a fourth intermediate feature map R′ⱼ₋₁, and the fourth intermediate feature map R′ⱼ₋₁ is obtained by performing convolution processing on a corresponding third feature map Rⱼ₋₁ using a fifth convolution kernel, where j is greater than 1 and less than or equal to m.

In some possible implementations, the key point detecting module is configured to perform feature fusion processing on each of the plurality of third feature maps to obtain a fourth feature map; and obtain the position of each key point in the input image based on the fourth feature map.

In some possible implementations, the key point detecting module is configured to adjust each of the third feature maps to feature maps of the same scale by means of linear interpolation; and connect the feature maps of the same scale to obtain the fourth feature maps.

In some possible implementations, the apparatus further includes: an optimizing module, configured to respectively input a first group of third feature maps to different bottleneck block structures for convolution processing, and respectively obtain updated third feature maps, each of the bottleneck block structures including a different number of convolution modules, where the third feature map includes a first group of third feature maps and a second group of third feature maps, and the first group of third feature maps and the second group of third feature maps each include at least one third feature map.

In some possible implementations, the key point detecting module is further configured to adjust each of the updated third feature maps and the second group of third feature maps to feature maps of the same scale by means of linear interpolation; and connect the feature maps of the same scale to obtain the fourth feature maps.

In some possible implementations, the key point detecting module is further configured to perform dimension reduction processing on the fourth feature maps by using a fifth convolution kernel; and determine the positions of key points of the input image by using the fourth feature maps subjected to the dimension reduction processing.

In some possible implementations, the key point detecting module is further configured to perform dimension reduction processing on the fourth feature maps by using a fifth convolution kernel; perform purification processing on the features in the fourth feature maps subjected to the dimension reduction processing by using a convolution block attention module to obtain the purified feature map; and determine the positions of the key points of the input image by using the purified feature maps.

In some possible implementations, the forward processing module is further configured to train the first pyramid neural network by using a training image data set, which includes: performing the forward processing on a first feature maps corresponding to each image in the training image data set by using the first pyramid neural network, to obtain a second feature map corresponding to each image in the training image data set; determining the identified key points by using each second feature map; obtaining a first loss of the key point according to a first loss function; and reversely regulating each convolution kernel in the first pyramid neural network by using the first loss until the number of trainings reaches a set first number of times threshold.

In some possible implementations, the reverse processing module is further configured to train the second pyramid neural network by using a training image data set, which includes: performing the reverse processing on the second feature map corresponding to each image in the training image data set output by the first pyramid neural network by using the second pyramid neural network to obtain a third feature map corresponding to each image in the training image data set; determining the identified key points by using each third feature map; obtaining a second loss of each identified key point according to a second loss function; and reversely regulating convolution kernels in the second pyramid neural network by using the second loss until the number of trainings reaches a set second number of times threshold; or reversely regulating the convolution kernels in the first pyramid neural network and the convolution kernels in the second pyramid neural network by using the second loss until the number of trainings reaches a set second number of times threshold.

In some possible implementations, the key point detecting module is further configured to perform feature fusion processing on each of the third feature maps by means of a feature extraction network, and before the feature fusion processing is performed on each of the third feature maps by means of a feature extraction network, further training the feature extraction network by using the training image data set includes: performing the feature fusion processing on the third feature map corresponding to each image in the training image data set output by the second pyramid neural network by using the feature extraction network, and identifying key points of each image in the training image data set by using the feature map subjected to the feature fusion processing; obtaining a third loss of each key point according to a third loss function; and reversely regulating parameters of the feature extraction network by using a third loss value until the number of trainings reaches a set third number of times threshold; or reversely regulating parameters of the convolution kernel in the first pyramid neural network, parameters of the convolution kernel in the second pyramid neural network, and parameters of the feature extraction network by using the third loss function until the number of training times reaches a set third number of times threshold.

In some embodiments, the functions provided by or the modules included in the apparatuses provided in the embodiments of the present disclosure may be used to implement the methods described in the foregoing method embodiments. For specific implementations, reference may be made to the description in the method embodiments above. For the purpose of brevity, details are not described herein repeatedly.

The embodiments of the present disclosure further provide a computer-readable storage medium, having computer program instructions stored thereon, where when the computer program instructions are executed by a processor, the foregoing method is implemented. The computer-readable storage medium may be a non-volatile computer-readable storage medium.

The embodiments of the present disclosure further provide an electronic device, including: a processor; and a memory configured to store processor-executable instructions, where the processor is configured to execute the foregoing method.

The electronic device may be provided as a terminal, a server, or other forms of devices.

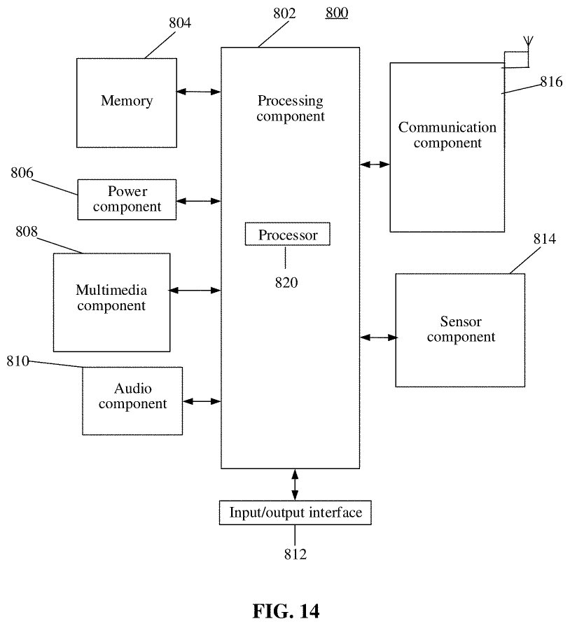

FIG. 14 shows a block diagram of an electronic device 800 according to embodiments of the present disclosure. For example, the electronic device 800 may be a terminal such as a mobile phone, a computer, a digital broadcast terminal, a message transceiver device, a game console, a tablet device, a medical device, exercise equipment, and a personal digital assistant.

With reference to FIG. 14, the electronic device 800 may include one or more of the following components: a processing component 802, a memory 804, a power supply component 806, a multimedia component 808, an audio component 810, an Input/Output (I/O) interface 812, a sensor component 814, and a communication component 816.

The processing component 802 generally controls overall operation of the electronic device 800, such as operations associated with display, phone calls, data communications, camera operations, and recording operations. The processing component 802 may include one or more processors 820 to execute instructions to implement all or some of the steps of the method above. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support operations on the electronic device 800. Examples of the data include instructions for any application or method operated on the electronic device 800, contact data, contact list data, messages, pictures, videos, and the like. The memory 804 may be implemented by any type of volatile or non-volatile storage device, or a combination thereof, such as a Static Random-Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a disk or an optical disk.

The power supply component 806 provides power for various components of the electronic device 800. The power supply component 806 may include a power management system, one or more power supplies, and other components associated with power generation, management, and distribution for the electronic device 800.

The multimedia component 808 includes a screen between the electronic device 800 and a user that provides an output interface. In some embodiments, the screen may include a Liquid Crystal Display (LCD) and a Touch Panel (TP). If the screen includes a TP, the screen may be implemented as a touch screen to receive input signals from the user. The TP includes one or more touch sensors for sensing touches, swipes, and gestures on the TP. The touch sensor may not only sense the boundary of a touch or swipe action, but also detect the duration and pressure related to the touch or swipe operation. In some embodiments, the multimedia component 808 includes a front-facing camera and/or a rear-facing camera. When the electronic device 800 is in an operation mode, for example, a photography mode or a video mode, the front-facing camera and/or the rear-facing camera may receive external multimedia data. Each of the front-facing camera and the rear-facing camera may be a fixed optical lens system, or have focal length and optical zoom capabilities.

The audio component 810 is configured to output and/or input an audio signal. For example, the audio component 810 includes a microphone (MIC), and the microphone is configured to receive an external audio signal when the electronic device 800 is in an operation mode, such as a calling mode, a recording mode, and a voice recognition mode. The received audio signal may be further stored in the memory 804 or transmitted by means of the communication component 816. In some embodiments, the audio component 810 further includes a loudspeaker for outputting the audio signal.

The I/O interface 812 provides an interface between the processing component 802 and a peripheral interface module, which may be a keyboard, a click wheel, a button, etc. The button may include, but is not limited to, a home button, a volume button, a start button, and a lock button.

The sensor component 814 includes one or more sensors for providing state assessment in various aspects for the electronic device 800. For example, the sensor component 814 may detect an on/off state of the electronic device 800, and relative positioning of components, which are the display and keypad of the electronic device 800, for example, and the sensor component 814 may further detect the position change of the electronic device 800 or a component of the electronic device 800, the presence or absence of contact of the user with the electronic device 800, the orientation or acceleration/deceleration of the electronic device 800, and a temperature change of the electronic device 800. The sensor component 814 may include a proximity sensor, which is configured to detect the presence of a nearby object when there is no physical contact. The sensor component 814 may further include a light sensor, such as a CMOS or CCD image sensor, for use in an imaging application. In some embodiments, the sensor component 814 may further include an acceleration sensor, a gyroscope sensor, a magnetic sensor, a pressure sensor, or a temperature sensor.

The communication component 816 is configured to facilitate wired or wireless communications between the electronic device 800 and other devices. The electronic device 800 may access a wireless network based on a communication standard, such as WiFi, 2G, or 3G, or a combination thereof. In an exemplary embodiment, the communication component 816 receives a broadcast signal or broadcast-related information from an external broadcast management system by means of a broadcast channel In an exemplary embodiment, the communication component 816 further includes a Near Field Communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology, and other technologies.

In an exemplary embodiment, the electronic device 800 may be implemented by one or more application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, or other electronic elements, to execute the method above.

In an exemplary embodiment, a non-volatile computer-readable storage medium is further provided, for example, a memory 804 including computer program instructions, which can executed by the processor 820 of the electronic device 800 to implement the method above.

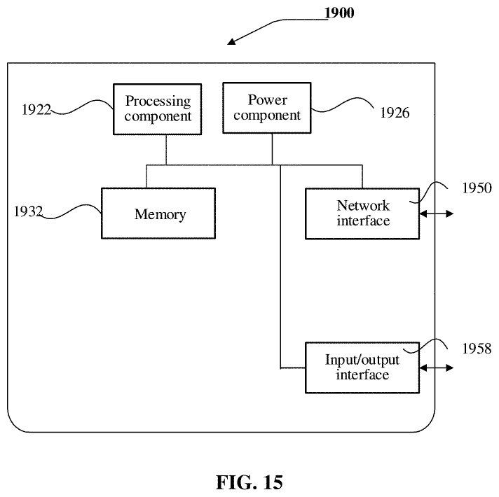

FIG. 15 shows a block diagram of an electronic device 1900 according to embodiments of the present disclosure. For example, the electronic device 1900 may be provided as a server. With reference to FIG. 15, the electronic device 1900 includes a processing component 1922 which further includes one or more processors, and a memory resource represented by a memory 1932 and configured to store instructions executable by the processing component 1922, for example, an application program. The application program stored in the memory 1932 may include one or more modules, each of which corresponds to a set of instructions. In addition, the processing component 1922 is configured to execute instructions so as to execute the method above.

The electronic device 1900 may further include a power supply component 1926 configured to execute power management of the electronic device 1900, a wired or wireless network interface 1950 configured to connect the electronic device 1900 to the network, and an I/O interface 1958. The electronic device 1900 may be operated based on an operating system stored in the memory 1932, such as Windows Server™, Mac OS X™, Unix™, Linux™, FreeBSD™ or the like.

In an exemplary embodiment, a non-volatile computer-readable storage medium is further provided, for example, a memory 1932 including computer program instructions, which can be executed by the processing component 1922 of the electronic device 1900 to implement the method above.

The present disclosure may be a system, a method, and/or a computer program product. The computer program product may include a computer-readable storage medium, on which computer-readable program instructions used by the processor to implement various aspects of the present disclosure are stored.

The computer-readable storage medium may be a tangible device that can maintain and store instructions used by an instruction execution device. The computer-readable storage medium may be, but is not limited to, an electronic storage device, a magnetic storage device, an optical storage device, an electromagnetic storage device, a semiconductor storage device, or any suitable combination of the foregoing. More specific examples (a non-exhaustive list) of the computer-readable storage medium include a portable computer disk, a hard disk, a Random Access Memory (RAM), a Read-Only Memory (ROM), an Erasable Programmable Read-Only Memory (EPROM or flash memory), a Static Random Access Memory (SRAM), a portable Compact Disc Read-Only Memory (CD-ROM), a Digital Versatile Disk (DVD), a memory stick, a floppy disk, a mechanical coding device such as a punched card storing an instruction or a protrusion structure in a groove, and any appropriate combination thereof. The computer-readable storage medium used here is not interpreted as an instantaneous signal such as a radio wave or other freely propagated electromagnetic wave, an electromagnetic wave propagated by a waveguide or other transmission media (for example, an optical pulse transmitted by an optical fiber cable), or an electrical signal transmitted by a wire.

Computer-readable program instructions described herein can be downloaded to respective computing/processing devices from a computer-readable storage medium or to an external computer or external storage device via a network, for example, the Internet, a Local Area Network (LAN), a Wide Area Network (WAN) and/or a wireless network. The network may computer copper transmission cables, optical transmission fibers, wireless transmission, routers, firewalls, switches, gateway computers and/or edge servers. A network adapter card or a network interface in each computing/processing device receives the computer-readable program instruction from the network, and forwards the computer-readable program instruction, so that the computer-readable program instruction is stored in a computer-readable storage medium in each computing/processing device.

Computer program instructions for carrying out operations of the present application may be assembler instructions, Instruction-Set-Architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer-readable program instructions can be completely executed on a user computer, partially executed on a user computer, executed as an independent software package, executed partially on a user computer and partially on a remote computer, or completely executed on a remote computer or a server. In a scenario involving a remote computer, the remote computer may be connected to the user's computer through any type of network, including a LAN or a WAN, or the connection may be made to an external computer (for example, through the Internet using an Internet service provider). In some embodiments, an electronic circuit such as a programmable logic circuit, a Field Programmable Gate Array (FPGA), or a Programmable Logic Array (PLA) is personalized by using status information of the computer-readable program instructions, and the electronic circuit can execute the computer-readable program instructions to implement various aspects of the present disclosure.

Various aspects of the present disclosure are described here with reference to the flowcharts and/or block diagrams of the methods, apparatuses (systems), and computer program products according to the embodiments of the present disclosure. It should be understood that each block in the flowcharts and/or block diagrams and a combination of the blocks in the flowcharts and/or block diagrams can be implemented with the computer-readable program instructions.

These computer-readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium, and these instructions instruct a computer, a programmable data processing apparatus, and/or other devices to work in a specific manner. Therefore, the computer-readable storage medium having the instructions stored thereon includes a manufacture, and the manufacture includes instructions in various aspects for implementing the specified function/action in the one or more blocks in the flowcharts and/or block diagrams.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus or other device implement the functions/acts specified in one or more blocks of the flowcharts and/or block diagrams.

The flowcharts and block diagrams in the accompanying drawings show architectures, functions, and operations that may be implemented by the systems, methods, and computer program products in the embodiments of the present disclosure. In this regard, each block in the flowcharts or block diagrams may represent a module, a program segment, or a part of instruction, and the module, the program segment, or the part of instruction includes one or more executable instructions for implementing a specified logical function. In some alternative implementations, the functions noted in the block may also occur out of the order noted in the accompanying drawings. For example, two consecutive blocks are actually executed substantially in parallel, or are sometimes executed in a reverse order, depending on the involved functions. It should also be noted that each block of the block diagrams and/or flowcharts, and combinations of blocks in the block diagrams and/or flowcharts, can be implemented by special purpose hardware-based systems that perform the specified functions or acts or carried out by combinations of special purpose hardware and computer instructions.

The embodiments of the present disclosure are described above. The foregoing descriptions are exemplary but not exhaustive, and are not limited to the disclosed embodiments. Many modifications and variations will be apparent to a person of ordinary skill in the art without departing from the scope and spirit of the described embodiments. The terminology used herein was chosen to best explain the principles of the embodiments, the practical application or technical improvement over technologies found in the marketplace, or to enable other persons of ordinary skill in the art to understand the embodiments disclosed herein.

1. A key point detection method, comprising:
obtaining a plurality of first feature maps at a plurality of scales for an input image, scales of the plurality of first feature maps having a multiple relationship;
performing forward processing on each of the plurality of first feature maps by using a first pyramid neural network to obtain a plurality of second feature maps in one-to-one correspondence to the plurality of first feature maps, wherein each of the plurality of second feature maps has the same scale as that of a first feature map corresponding to the second feature map;
performing reverse processing on each of the plurality of second feature maps by using a second pyramid neural network to obtain a plurality of third feature maps in one-to-one correspondence to the plurality of second feature maps, wherein each of the plurality of third feature maps has the same scale as that of a second feature map corresponding to the third feature map; and
performing feature fusion processing on each of the plurality of third feature maps, and obtaining a position of each key point in the input image by using a feature map subjected to the feature fusion processing.

2. The method according to claim 1, wherein the obtaining the plurality of first feature maps at the plurality of scales for the input image comprises:
adjusting the input image to a first image of a preset specification; and
inputting the first image to a residual neural network, and performing downsampling processing at different sampling frequencies on the first image to obtain a plurality of first feature maps at different scales.

3. The method according to claim 1, wherein the forward processing comprises first convolution processing and first linear interpolation processing, and the reverse processing comprises second convolution processing and second linear interpolation processing.

4. The method according to claim 1, wherein the performing forward processing on each of the plurality of first feature maps by using a first pyramid neural network to obtain a plurality of second feature maps in one-to-one correspondence to the plurality of first feature maps comprises:
performing convolution processing on a first feature map Cₙ in first feature maps C₁ . . . Cₙ by using a first convolution kernel to obtain a second feature map Fₙ corresponding to the first feature map Cₙ, wherein n represents a number of the first feature maps, and n is an integer greater than 1;
performing linear interpolation processing on the second feature map Fₙ to obtain a first intermediate feature map F′ₙ corresponding to the second feature map Fₙ, wherein the first intermediate feature map F′ₙ has the same scale as that of a first feature map Cₙ₋₁;
performing convolution processing on first feature maps C₁ . . . Cₙ₋₁ other than the first feature map Cₙ by using a second convolution kernel to obtain second intermediate feature maps C′₁ . . . C′ₙ₋₁ respectively in one-to-one correspondence to the first feature maps C₁ . . . Cₙ₋₁, wherein each of the second intermediate feature maps has the same scale as that of a first feature map corresponding to the second intermediate feature map; and
obtaining second feature maps F₁ . . . Fₙ₋₁ and first intermediate feature maps F′₁ . . . F′ₙ₋₁ based on the second feature map Fₙ and each of the second intermediate feature maps C′₁ . . . C′ₙ₋₁, wherein the second feature map Fᵢ is obtained by performing superposition processing on the second intermediate feature map C′ᵢ and the first intermediate feature map F′ᵢ₊₁, the first intermediate feature map F′ᵢ is obtained by performing linear interpolation processing on its corresponding second feature map Fᵢ, and the second intermediate feature map C′ᵢ has the same scale as that of the first intermediate feature map F′ᵢ₊₁, wherein i is an integer greater than or equal to 1 and less than n.

5. The method according to claim 1, wherein the performing reverse processing on each of the plurality of second feature maps by using the second pyramid neural network to obtain the plurality of third feature maps in one-to-one correspondence to the plurality of second feature maps comprises:
performing convolution processing on a second feature map F₁ in second feature maps F₁ . . . Fₘ by using a third convolution kernel to obtain a third feature map R₁ corresponding to the second feature map F₁, wherein m represents a number of the second feature maps, and m is an integer greater than 1;
performing convolution processing on second feature maps F₂ . . . Fₘ by using a fourth convolution kernel to obtain respective third intermediate feature maps F″₂ . . . F″ₘ, wherein each of the third intermediate feature maps has the same scale as that of a second feature map corresponding to the third intermediate feature map;
performing convolution processing on the third feature map R₁ by using a fifth convolution kernel to obtain a fourth intermediate feature map R′₁ corresponding to the third feature map R₁; and
obtaining third feature maps R₂ . . . Rₘ and fourth intermediate feature maps R′₂ . . . R′ₘ by using the third intermediate feature maps F″₂ . . . F″ₘ and the fourth intermediate feature map R′₁, wherein a third feature map Rⱼ is obtained by superposition processing of a third intermediate feature map F″ⱼ and a fourth intermediate feature map R′ⱼ₋₁, and the fourth intermediate feature map R′ⱼ₋₁ is obtained by performing convolution processing on its corresponding third feature map Rⱼ₋₁ by using a fifth convolution kernel, wherein j is greater than 1 and less than or equal to m.

6. The method according to claim 1, wherein the performing feature fusion processing on each of the plurality of third feature maps, and obtaining the position of each key point in the input image by using the feature map subjected to the feature fusion processing comprises:
performing feature fusion processing on each of the plurality of third feature maps to obtain a fourth feature map; and
obtaining the position of each key point in the input image based on the fourth feature map.

7. The method according to claim 6, wherein the performing feature fusion processing on each of the plurality of third feature maps to obtain the fourth feature map comprises:
adjusting each of the plurality of third feature maps to a plurality of feature maps of the same scale by using linear interpolation; and
connecting the plurality of feature maps of the same scale to obtain the fourth feature map.

8. The method according to claim 6, wherein before the performing feature fusion processing on each of the plurality of third feature maps to obtain the fourth feature map, the method further comprises:
respectively inputting a first group of third feature maps to different bottleneck block structures, and perform convolution processing on the first group of third feature maps to respectively obtain updated third feature maps, each of the bottleneck block structures comprising a different number of convolution modules, wherein the plurality of third feature maps comprise the first group of third feature maps and a second group of third feature maps, and the first group of third feature maps and the second group of third feature maps each comprises at least one third feature map.

9. The method according to claim 8, wherein the performing feature fusion processing on each of the plurality of third feature maps to obtain the fourth feature map comprises:
adjusting each of the updated third feature maps and the second group of third feature maps to feature maps of the same scale by using linear interpolation; and
connecting the feature maps of the same scale to obtain the fourth feature map.

10. The method according to claim 6, wherein the obtaining the position of each key point in the input image based on the fourth feature map comprises:
performing dimension reduction processing on the fourth feature map by using a fifth convolution kernel; and
determining the positions of key points of the input image by using a fourth feature map subjected to the dimension reduction processing.

11. The method according to claim 1, wherein the obtaining the position of each key point in the input image based on the fourth feature map comprises:
performing dimension reduction processing on the fourth feature map by using a fifth convolution kernel;
performing purification processing on features in the fourth feature map subjected to the dimension reduction processing by using a convolution block attention module to obtain a purified feature map; and
determining the positions of the key points of the input image by using a purified feature map.

12. The method according to claim 1, further comprising: training the first pyramid neural network by using a training image data set, comprising:
performing the forward processing on a plurality of first feature maps corresponding to each image in the training image data set by using the first pyramid neural network, to obtain a plurality of second feature maps corresponding to each image in the training image data set;
determining the obtained key points by using each second feature map;
obtaining a first loss of each key point according to a first loss function; and
reversely regulating each convolution kernel in the first pyramid neural network by using the first loss until a number of trainings reaches a set first threshold number of times.

13. The method according to claim 1, further comprising: training the second pyramid neural network by using a training image data set, comprising:
performing, by using the second pyramid neural network, the reverse processing on the plurality of second feature map corresponding to each image in the training image data set output by the first pyramid neural network, to obtain a plurality of third feature map corresponding to each image in the training image data set;
determining the obtained key points by using each of the plurality of third feature maps;
obtaining a second loss of each key point according to a second loss function; and
reversely regulating convolution kernels in the second pyramid neural network by using the second loss until the number of trainings reaches a set second threshold number of times; or reversely regulating the convolution kernels in the first pyramid neural network and the convolution kernels in the second pyramid neural network by using the second loss until the number of trainings reaches the set second threshold number of times.

14. The method according to claim 1, wherein the feature fusion processing is performed on each of the plurality of third feature maps by using a feature extraction network, and
before the performing feature fusion processing on each of the plurality of third feature maps by using a feature extraction network, the method further comprises: training the feature extraction network by using the training image data set, comprising:
performing, by using the feature extraction network, the feature fusion processing on the plurality of third feature maps corresponding to each image in the training image data set output by the second pyramid neural network, and identifying key points of each image in the training image data set by using a feature map subjected to the feature fusion processing;
obtaining a third loss of each key point according to a third loss function; and
reversely regulating parameters of the feature extraction network by using a third loss value until the number of trainings reaches a set third threshold number of times; or reversely regulating, by using the third loss function, parameters of the convolution kernel in the first pyramid neural network, parameters of the convolution kernel in the second pyramid neural network, and parameters of the feature extraction network, until the number of training times reaches a set third threshold number of times.

15. A key point detection apparatus, comprising:
a processor; and
a memory configured to storing instructions executable by the processor,
wherein the processor is configured to:
obtain a plurality of first feature maps at a plurality of scales for an input image, scales of the plurality of first feature maps having a multiple relationship;
perform forward processing on each of the plurality of first feature maps by using a first pyramid neural network to obtain a plurality of second feature maps in one-to-one correspondence to the plurality of first feature maps, wherein each of the plurality of second feature maps has the same scale as that of a first feature map corresponding to the second feature map;
perform reverse processing on each of the plurality of second feature maps by using a second pyramid neural network to obtain a plurality of third feature maps in one-to-one correspondence to the plurality of second feature maps, wherein each of the plurality of third feature maps has the same scale as that of a second feature map corresponding to the third feature map; and
perform feature fusion processing on each of the plurality of third feature maps, and obtain a position of each key point in the input image by using a feature map subjected to the feature fusion processing.

16. The apparatus according to claim 15, wherein the processor is configured to adjust the input image to a first image of a preset specification; and input the first image to a residual neural network, and perform downsampling processing at different sampling frequencies on the first image to obtain a plurality of first feature maps at different scales.

17. The apparatus according to claim 15, wherein the processor is configured to:
perform convolution processing on a first feature map Cₙ in first feature maps C₁ . . . Cₙ by using a first convolution kernel to obtain a second feature map Fₙ corresponding to the first feature map Cₙ, wherein n represents a number of the first feature maps, and n is an integer greater than 1;
perform linear interpolation processing on the second feature map Fₙ to obtain a first intermediate feature map F′ₙ corresponding to the second feature map Fₙ, wherein the first intermediate feature map F′ₙ has the same scale as that of a first feature map Cₙ₋₁;
perform convolution processing on first feature maps C₁ . . . Cₙ₋₁ other than the first feature map Cₙ by using a second convolution kernel to obtain second intermediate feature maps C′₁ . . . C′ₙ₋₁ respectively in one-to-one correspondence to the first feature maps C₁ . . . Cₙ₋₁, wherein each of the second intermediate feature maps has the same scale as that of a first feature maps corresponding to the second intermediate feature map; and
obtain second feature maps F₁ . . . Fₙ₋₁ and first intermediate feature maps F′₁, . . . F′ₙ₋₁ based on the second feature map Fₙ and each of the second intermediate feature maps C′₁ . . . C′ₙ₋₁, wherein the second feature map Fᵢ is obtained by performing superposition processing on the second intermediate feature map C′ᵢ and the first intermediate feature map F′ᵢ₊₁, the first intermediate feature map F′ᵢ is obtained by performing linear interpolation on its corresponding second feature map Fᵢ, and the second intermediate feature map C′ᵢ has the same scale as that of the first intermediate feature map F′ᵢ₊₁, wherein i is an integer greater than or equal to 1 and less than n.

18. The apparatus according to claim 15, wherein the processor is configured to:
perform convolution processing on a second feature map F₁ in second feature maps F₁ . . . Fₘ by using a third convolution kernel to obtain a third feature map R₁ corresponding to the second feature map F₁, wherein m represents a number of the second feature maps, and m is an integer greater than 1;
perform convolution processing on second feature maps F₂ . . . Fₘ by using a fourth convolution kernel to obtain respective third intermediate feature maps F″₂ . . . F″ₘ, wherein each of the third intermediate feature maps has the same scale as that of a second feature map corresponding to the third intermediate feature map;
perform convolution processing on the third feature map R₁ by using a fifth convolution kernel to obtain a fourth intermediate feature map R′₁ corresponding to the third feature map R₁; and
obtain third feature maps R₂ . . . Rₘ and fourth intermediate feature maps R′₂ . . . R′ₘ by using the third intermediate feature maps F″₂ . . . F″ₘ and the fourth intermediate feature map R′₁, wherein a third feature map Rⱼ is obtained by superposition processing of a third intermediate feature map F″ⱼ and a fourth intermediate feature map R′ⱼ₋₁, and the fourth intermediate feature map R′ⱼ₋₁ is obtained by performing convolution processing on its corresponding third feature map Rⱼ₋₁ by using a fifth convolution kernel, wherein j is greater than 1 and less than or equal to m.

19. The apparatus according to claim 15, wherein the processor is configured to perform feature fusion processing on each of the plurality of third feature maps to obtain a fourth feature map; and obtain the position of each key point in the input image based on the fourth feature map.

20. A non-transitory computer-readable storage medium, having stored thereon computer program instructions that, when being executed by a processor, implements a key point detection method, comprising:
obtaining a plurality of first feature maps at a plurality of scales for an input image, scales of the plurality of first feature maps having a multiple relationship;
performing forward processing on each of the plurality of first feature maps by using a first pyramid neural network to obtain a plurality of second feature maps in one-to-one correspondence to the plurality of first feature maps, wherein each of the plurality of second feature maps has the same scale as that of a first feature map corresponding to the second feature map;
performing reverse processing on each of the plurality of second feature maps by using a second pyramid neural network to obtain a plurality of third feature maps in one-to-one correspondence to the plurality of second feature maps, wherein each of the plurality of third feature maps has the same scale as that of a second feature map corresponding to the third feature map; and
performing feature fusion processing on each of the plurality of third feature maps, and obtaining a position of each key point in the input image by using a feature map subjected to the feature fusion processing.
